(19) United States
(12) Patent Application Publication
(10) Pub. No.: US 2004/0193746 A1
(43) Pub. Date: Sep. 30, 2004

(54) Service search device, service search method and document processing system

(75) Inventor: Takayuki Koyama, Kawasaki-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/745,553

(22) Filed: Dec. 29, 2003

(30) Foreign Application Priority Data
Mar. 24, 2003 (JP) 2003-081612

(51) Int. Cl. G06F 3/00

(52) U.S. Cl. 710/9

(57) ABSTRACT

A service search device includes a receiver that receives a search condition for searching a service which executes a process on document data, a searching controller that searches a service processor for providing the service corresponding to the search condition received by the receiver through a network where plural service processors are connected to execute the process on the document data, and a transmitter that transmits a search result of the searching controller.

### BACKGROUND OF THE INVENTION

The present invention relates to a service search device, a service search method and program, and a document processing system and particularly to a service search device for searching desired services from various services connected to a network, a service search method and program, and a document processing system.

It is known a network system which can quickly take a measure for a fault generated in the transmission line by monitoring the transmitting conditions of facsimile data.

The network system is provided with a center device for distributing data to the registered users via the Internet and plural access points for selective transmission of data supplied via the Internet to the public transmission lines.

The center device distributes data with a file transfer protocol in the format of facsimile data, monitors generation of transmission fault in the facsimile data transmission path, detects an alternative transmission path including an alternative access point in place of the transmission path where a transmission fault is searched when the transmission fault is detected, and distributes the facsimile data through the searched transmission path.

(See, for Example, JP-A-2000-99422 (FIG. 1).)

Accordingly, the network system described in JP-A-2000-99422 is capable of eliminating the situation where the facsimile data is accumulated on the transmission path including the access point which has generated a transmission fault and therefore the facsimile data of the facsimile device in the user side is not transmitted.

Some users demand to find the services to execute predetermined processes for document data from a network and to search the services not restricted in charge (fee) and time. However, the network system described in JP-A-2000-99422 does not satisfy the demand of users described above.

### SUMMARY OF THE INVENTION

The present invention has been proposed in view of addressing the problem described above and it is therefore intended to provide a service search device, a service search method and a document processing system which can easily find the services to execute the processes on document data from networks depending on the requests of users.

According to one aspect of the present invention, a service search device includes a receiver that receives a search condition for searching a service which executes a process on document data, a searching controller that searches a service processor to provide the service corresponding to the search condition received by the receiver through a network where plural service processors are connected to execute the process on the document data, and a transmitter that transmits a search result of the searching controller.

The searching controller may search a service processor to provide the service corresponding to the search condition by sending an inquiry to each of the service processors. Therefore, the service processor may be searched without predetermined preparation for search.

The service search device may include a service information memory that stores service information indicating the service provided by each of the service processors. The searching controller may search the service processor to provide the service corresponding to the search condition from the service information stored in the service information memory. Therefore, the service processor to provide the service corresponding to the search condition can be easily searched, without direct inquiry to each of the service processors, by storing the service information indicating the service provided by each of the service processors.

The transmitter may transmit a list of one or more service processors searched by the searching controller.

Therefore, it is possible to give a user a chance to select the desired service processor by transmitting the list.

The service search method according to another aspect of the present invention includes a receiving step to receive a search condition for searching a service which executes a process on document data, a searching step to search a service processor to provide the service corresponding to the search condition received by the receiving step through a network where plural service processors are connected to execute the process on the document data, and a transmitting step to transmit a search result of the searching step.

The service processor to provide the service corresponding to the search condition may be searched by sending inquiry to each of the service processors in the search step.

The service search method may include a storing step of storing service information indicating the service provided by each of the plural service processors.

The service processor to provide the service corresponding to the search condition may also be searched by referring to the service information indicating the service provided by each of the service processors.

A list of one or more service processors searched in the searching step may be transmitted in the transmitting step.

According to another aspect of the present invention, a document processing system includes the above-described service search device and a cooperation process device to execute a cooperated process of plural services based on cooperation instruction information indicating the cooperated process of plural services on a network. The cooperation process device transmits, when the service processor indicated by the cooperation instruction information cannot be used for execution, a search condition to search another service processor corresponding to the service processor from the network to the service search device, receives a search result from the service search device, and makes the other service processor indicated by the received search result execute the process in place of the service processor.

Therefore, the cooperated process can be executed by searching an alternative service processor even when the predetermined service processor is proved not to be executable during execution of cooperated processes of plural services.

### BRIEF DESCRIPTION OF THE DRAWINGS

The preferred embodiments of the present invention will be described in detail based on the followings, wherein:

FIG. 1 is a block diagram showing an exemplary structure of a document processing system as a first embodiment of the present invention;

FIG. 2 is a block diagram for describing mutual relationship among service processors forming the document processing system;

FIG. 3 is a diagram showing a format of the I/F information;

FIG. 4 is a diagram showing an instruction form creation image as a GUI image to define a job flow;

FIG. 5 is a diagram showing the instruction form formed in the XML format;

FIG. 6 is a block diagram showing a detail structure of a service search server;

FIG. 7 is a table for describing an example of the service information;

FIG. 8 is a flowchart showing the processing procedures of a client terminal and the instruction form creation server when the instruction form is created;

FIG. 9 is a flowchart showing the processes of a client terminal, an instruction form management server and a cooperation process server;

FIG. 10 is a diagram showing an example of the service cooperation process selection image indicating an instruction form list;

FIG. 11 is a flowchart showing processing procedures of the service search server to search the services;

FIG. 12 is a block diagram for describing the mutual relationship among service processors forming the document processing system as a second embodiment of the present invention; and

FIG. 13 is a block diagram for describing the mutual relationship under the execution of search of the service processors forming the document processing system.

### DETAILED DESCRIPTION OF THE EMBODIMENTS

Preferred exemplary embodiments of the present invention will be described in detail with reference to the accompanying drawings.

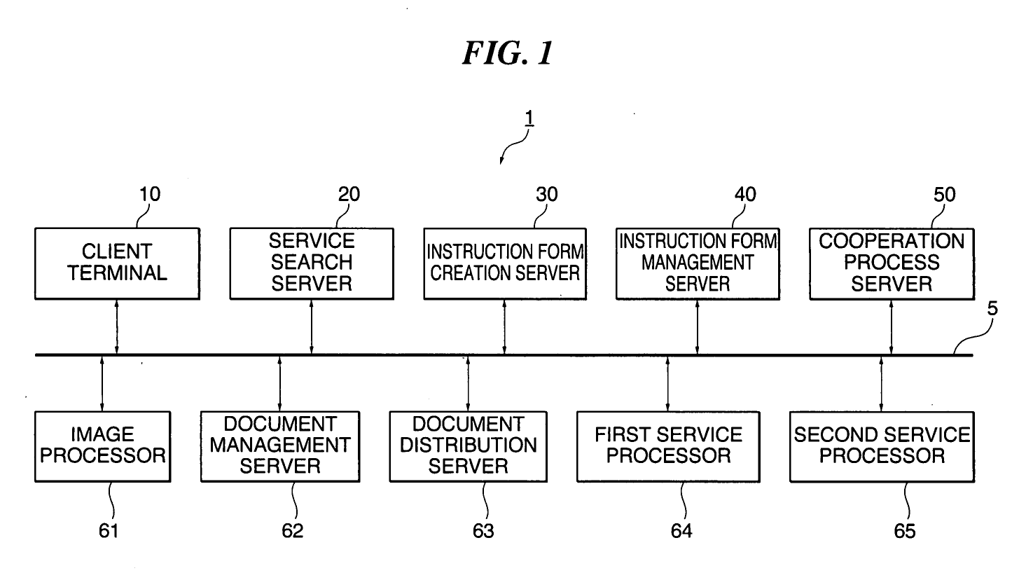

FIG. 1 is a block diagram showing an exemplary structure of a document processing system as a first embodiment of the present invention.

The document processing system 1 is formed of various services and applications connected via a network 5. Here, services are referred to as the available functions for documents depending on the requests from the external side. For example, these services correspond to copying, printing, scanning, facsimile transmission and reception, mail distribution, storing to repository and reading from repository, OCR (Optical Character Recognition) process, and noise elimination process or the like and are never restricted thereto.

The document processing system 1 is provided with a client terminal 10 including a user interface to instruct the predetermined processes through cooperation of plural services, a service search server 20 to search the predetermined services of users, an instruction form creation server 30 to create an instruction form from the information about service cooperation instructed by the client terminal 10, an instruction form management server 40 to perform management of an instruction form, and a cooperation process server 50 to execute cooperated processes of service depending on the instruction form.

The document processing system 1 is also provided with an image processor 61 to execute a noise elimination process of an image document, an image rotating process, OCR process and image processes such as binding of images, a document management server 62 to perform document management, a document distribution server 63 to distribute documents, a first service processor 64 to execute the first service process, and a second service processor 65 to execute the second service process.

The document processing system 1 is formed, in this embodiment, of plural servers to execute the predetermined service processes connected via a network 5 and is never restricted thereto so long as the plural services are connected via the network 5.

The instruction form is referred to, when a series of processes are decomposed to plural functional processes, as the data including the information to indicate relationship among functions, the interface (I/F) information to call respective functions, and the information to structure the graphical user interface (GUI) regarding a series of processes.

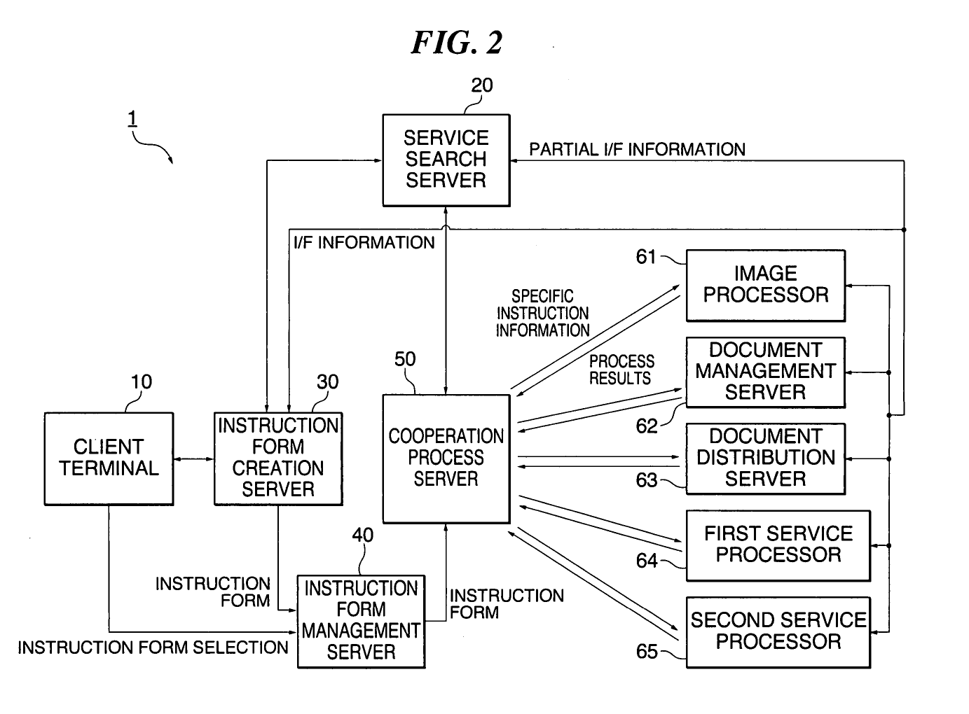

FIG. 2 is a block diagram for describing mutual relationship of service processors forming the document processing system 1. Each service processor stores the I/F information indicating contents of the services thereof.

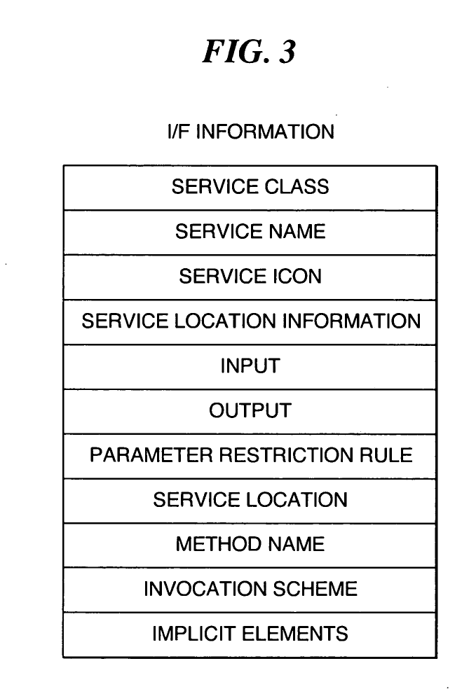

FIG. 3 is a diagram showing a format of the I/F information. The I/F information is formed of <service class>, <service name>, <service icon>, <service location information>, <input>, <output>, <parameter restriction rule>, <service location>, <method name> and <invocation scheme>, <implicit elements>.

The <service class> indicates a kind of service provided by the service processor. As the <service class>, the predetermined service class such as scanning, printing, repository and flow or the like is defined. The <service name> indicates a name of service provided by the service processor. The <service icon> indicates the position information of icon displayed in the GUI of the client terminal 10.

The <service location information> indicates the URL (Uniform Resource Locator) used by the instruction form creation server 30 to obtain the I/F information. The <input> indicates an input to the service. The <output> indicates an output from the service. The <parameter restriction rule> indicates the restriction rule applied to the <input> and <output>. The <service location> indicates the position information when the service is actually used. The <method name> indicates a method to provide the service process and a name to suggest the service.

The <invocation scheme> indicates a method to call and invoke the service process. As the <invocation scheme>, for example, SOAP (Simple Object Access Protocol) and SMTP (Simple Mail Transfer Protocol), which are the protocols for exchange of messages, may be used. The <implicit elements> implicitly indicate the data which is not transferred to the processes of the subsequent stage as an output but allows reference thereto in the processes of the subsequent stage.

The client terminal 10 is provided with the function of graphical user interface (GUI) to execute display of images and the predetermined operations in order to instruct creation of the instruction form and select the instruction form to be invoked.

The service search server 20 searches the services corresponding to the search conditions from plural services connected to the network 5. The service search server 20 previously stores a part of the I/F information (hereinafter referred to as the “partial I/F information”) of various service processors such as the image processor 61, document management server 62, document distribution server 63, first service processor 64, and second service processor 65, etc. The partial I/F information indicates the <service class>, <service name>, <service location information> in the elements of the I/F information, <input> information and <output> information.

The service search server 20 searches the services using the partial I/F information of each service processor when the search conditions are transmitted from the instruction form creation server 30 and cooperation process server 50. For example, it is enough for the service search server 20, at the time of searching the service similar to the predetermined service, to search the services where the <service class> is matched, the services where the <input> and the <output> are matched, or the services where these elements are all matched.

The instruction form creation server 30 obtains the I/F information from each service processor at the time of creating the instruction form and thereby creates the instruction form for cooperation of services provided with the service processors. The instruction form creation server 30 executes the following processes in order to create the instruction form.

The instruction form creation server 30 requests, based on the <service location information>, to transmit the I/F information about each service from the predetermined service processors located on the network 5. The instruction form creation server 30 issues, when there is no predetermined service processors, an instruction to the service search server 20 to search another service processor to execute the same service as that of the predetermined service processor. Thereafter, the instruction form creation server 30 obtains the <service location information> of the other service processor from the service search server 20.

The instruction form creation server 30 performs management of the result of search from the service search server 20 and the I/F information received from the service processors. In addition, the instruction form creation server 30 creates an HTML file which becomes a GUI image to define a job flow based on the I/F information obtained from each service processor. When the request to read the service is issued from the client terminal 10, the instruction form creation server 30 transmits the HTML file which becomes the GUI image to the client terminal 10.

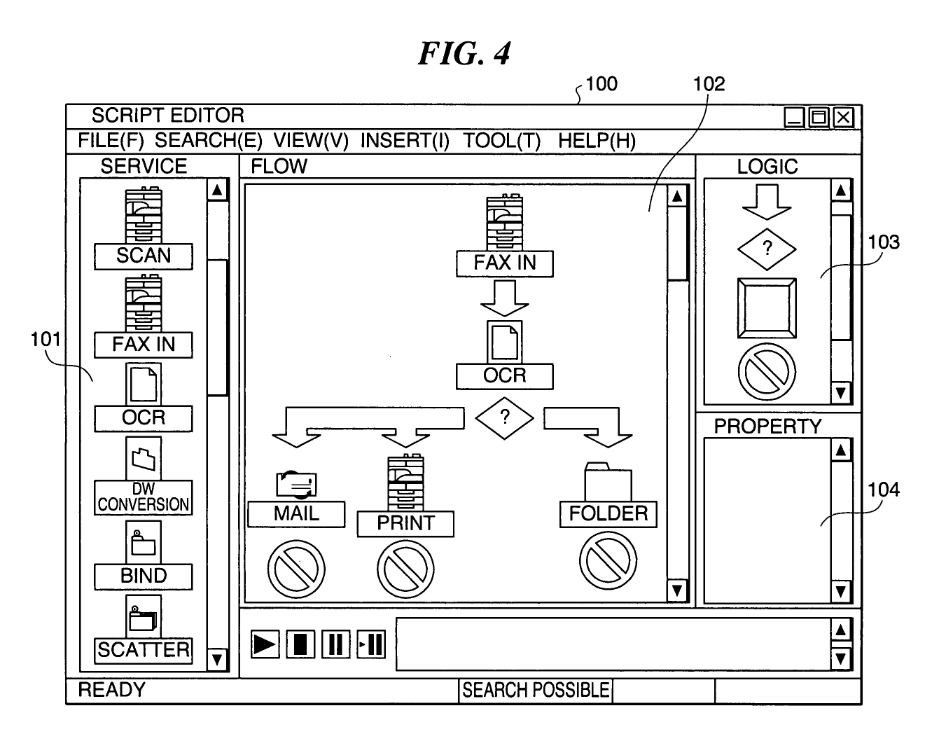

FIG. 4 is a diagram showing the instruction form creation image 100 which is the GUI image to define a job flow. The instruction form creation image 100 is formed of a service window 101, a flow window 102, a logic window 103 and a property window 104.

The service window 101 is used to display various available service processors. The logic window 103 is used to display the job flow to indicate the cooperation pattern among the services. The property window 104 is used to display detail setting parameters of each icon displayed on the service window 101 and logic window 103.

A user is capable of defining a job flow in the flow window 102 through the drag-and-drop of the icons of the service window 101 and logic window 103 to the flow window 102. Moreover, a user is also capable of setting the services and detail relationship among services such as logic by editing the contents displayed in the property window 104.

The client terminal 10 transmits the job flow information defined with the users' operation to the instruction form creation server 30.

The instruction form creation server 30 creates, based on the job flow information about instruction of service cooperation from users and the I/F information of each service, the instruction form defining the contents of process requested to each service, input parameter, a way of cooperation of each service job flow) and the information to identify the document as the process object such as the document name and storing location information or the like. The instruction form is formed, in this embodiment, as a file of the XML format.

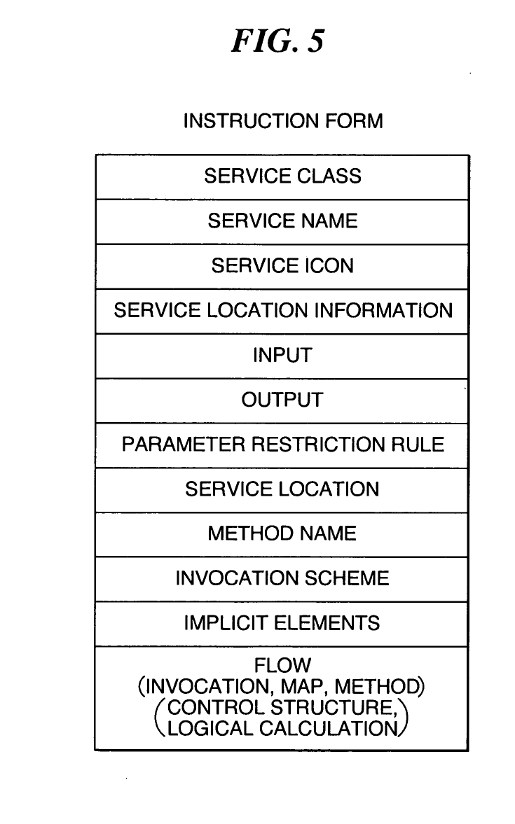

FIG. 5 is a diagram showing the concept of the instruction form formed in the XML format. Since the cooperated process itself of plural services can be considered as a service, the instruction form is formed in the format where the <flow> element is added to the I/F information illustrated in FIG. 3.

The <flow> is the element to describe the cooperation among services. This <flow> element includes <invoke>, control structure and logical calculation, element <if> for determining conditions, operation instruction of XML structure for adjustment of cooperation among services and the information to identify the document as the process object.

The element <invoke> indicates the particular method of service processor in order to call the services. As the element of <invoke>, the <map> indicating the position information of parameter and the method name <method> to be called. The elements <if>, <and>, <eq>, <gt> indicating the control structure and logical calculation or the like are used for branching of condition while the cooperated processes are executed and for adjustment of parameters transferred among the services.

The instruction form describes complete information about the control of cooperated process of services to the element <flow>. Therefore, the cooperated process itself indicated by the instruction form is also considered as a service. The instruction form is never restricted to the format illustrated in FIG. 5 and it is enough when each service may be cooperated with each other. The information described in the instruction form will be described later in detail, but such data is also used at the time of search by an alternative service processor.

The instruction form creation server 30 transmits the instruction form of the XML format as described above to the instruction form management server 40. The instruction form creation server 30 is also capable of transmitting the instruction form in direct to the cooperation process server 50 when a user instructs the execution of the service cooperation process.

The instruction form management server 40 stores the instruction form transmitted from the instruction form creation server 30 and transmits the instruction form to the cooperation process server 50 depending on the request from the client terminal 10.

The cooperation process server 50 is provided to interpret and execute the designated instruction form. When the instruction form is transmitted, the cooperation process server 50 interprets the instruction form, sequentially calls service processors such as the image processor 61, document management server 62 and document distribution server 63 or the like depending on the sequence and application method described in the instruction form, and then executes the cooperated process. Moreover, the cooperation process server 50 stores the conditions of cooperated process being executed and the information about a result of cooperated process completed and also notifies the conditions and results of cooperated process depending on the request from the external side.

The cooperation process server 50 interprets the instruction form and creates, at the time of sending a request to the service processors, the specific instruction information including process request contents, input parameter and the information to identify the document as the process object. The cooperation process server 50 is capable of extracting the information related to the service process before and after the cooperated process among those executed by each service processor and the describing such information to the instruction form, and is also capable of sending the request of process in the intrinsic information exchange format of every service processor in place of the format of instruction form.

The image processor 61 is a computer in which a software program for the image processing function is installed. The image processor 61 processes documents based on the service process request contents, input parameter and the information of process object document included in the process request from the cooperation process server 50. Moreover, the image processor 61 gives, when it is invoked, the partial I/F information to the service search server 20. In addition, the image processor 61 transmits the I/F information indicating application method of the image process service responding to the request from the instruction form creation server 30. This I/F information can be used when the instruction form is created.

The document management server 62 has a document storing function. The document management server 62 stores, searches, and reads, based on the information included in the request from the cooperation process server 50, the documents and executes change of attribute and various processes of documents. The document management server 62 gives, when it is invoked, the partial I/F information to the service search server 20. The document management server 62 transmits the I/F information indicating the application method of the document management service in response to the request from the instruction form creation server 30.

The document distribution server 63 is provided with functions to store the document obtained to the instructed document management server, transmits mail or facsimile data to the instructed transmission destination addresses and to execute the output process to the instructed printer. The document distribution server 63 executes the document distribution process based on the document and the information of distribution destination address instructed by the client terminal 10 in response to the request from the cooperation process server 50. The document distribution server 63 gives, when it is invoked, to the partial I/F information to the service search server 20. In addition, the document distribution server 63 transmits the I/F information indicating the application method of distribution process service in response to the request from the instruction form creation server 30.

The first service processor 64 is a device to execute the predetermined service process for the document depending on the instructions from external side. The first service processor 64 executes the service processes to be executed thereby based on the process request contents, input parameters and the information for identifying the process object document from the cooperation process server 50. The first service processor 64 gives, when it is invoked, the partial I/F information to the service search server 20. The first service processor 64 also transmits the I/F information indicating the application method in response to the request from the instruction form creation server 30. The second service processor 65 operates in the same manner as the first service processor 64, except for the contents of the service process.

In the document processing system 1 formed as described above, the service processors such as the image processor 61, document management server 62 and document distribution server 63 or the like operate as described below when the application programs to execute the predetermined processes are installed thereto.

The service processors such as the image processor 61, document management server 62 and document distribution server 63 or the like gives, when they are invoked, the partial I/F information including the information about summary of service and address to the service search server 20.

The service search server 20 stores the partial I/F information transmitted from the service processors such as the image processor 61, document management server 62 and document distribution server 63 or the like. The service search server 20 can execute the search using the partial I/F information when the predetermined service search request is issued, for example, from the instruction form creation server 30 and cooperation process server 50.

The service search server 20 is also capable of executing, in addition to the operations described above, the search using the service information including the partial I/F information.

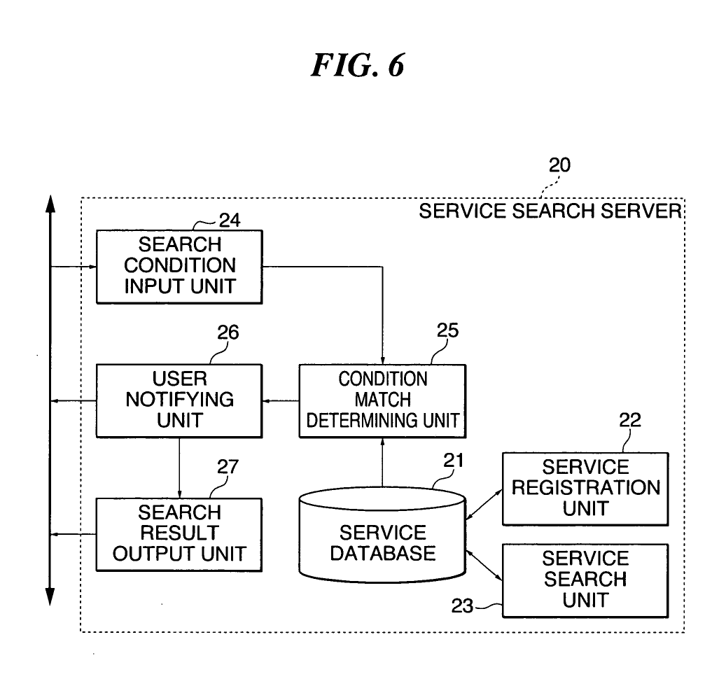

FIG. 6 is a block diagram showing a detail exemplary structure of the service search server 20. The service search server 20 is formed of a computer in which a service search control program, for example, is installed. The service search server 20 is provided with a service database 21 to store the service information, a service registering unit 22 to register the partial I/F information and service information of each service, a service search unit 23 to search the service, a search condition input unit 24 to input the search conditions, a condition match determining unit 25 to search the service matched with the search condition, a user notifying unit 26 to notify the message to users and a search result output unit 27 to output the search result.

Any type of the information used to search the services may be used as the service information and this service information includes the I/F information and other information in addition to the partial I/F information described above. The service information covers, for example, “service function”, “requirement for service”, “provider”, “service location”, “connectivity”, “cost”, and “access right”.

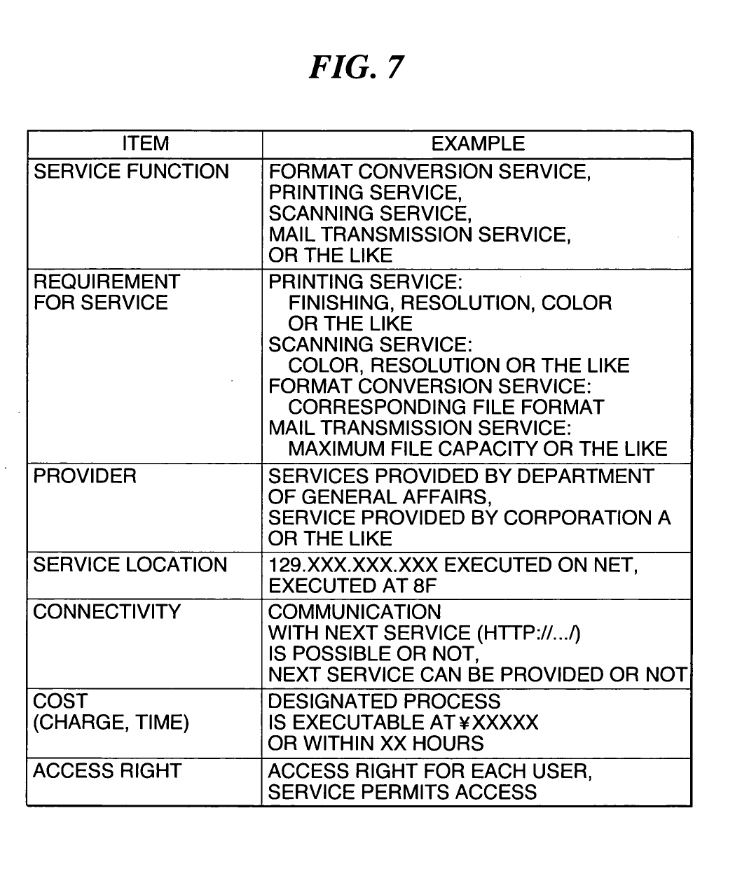

FIG. 7 is a table showing an example of service information. The “service function” is used to classify the functions of services and is identified with the predetermined service ID, and <service class>, <input> and <output>of the partial I/F information. The <service function> corresponds, for example, to format conversion service, printing service, scanning service and mail transmission service.

The “requirement for service” is used to designate the requirements for respective services. For example, it corresponds to finishing, resolution and color or the like in the case of the printing service, or to color and resolution or the like in the case of the scanning service. It also corresponds to the format of corresponding file in the case of format conversion service, and to the maximum file capacity in the mail transmission service.

The “provider” is used to designate a provider which offers services (for example, operation company or department). The operation company corresponds, for example, to Company A and the department corresponds to the Department of General Affairs.

The “service location” designates a physical or logical location for execution of a service. This is one of the I/F information elements illustrated in FIG. 3. The “service location” is not restricted, for example, to “129.xxx.xxx. xxx” used as the IP address and may be used in the form of “executed on the network” or “executed in the 8F”.

The “connectivity” indicates whether the cooperated function should be provided or not to the next service process in a series of job flow described in the instruction form. The “connectivity” indicates, for example, “whether communication with the next service process (http:// . . . /) is possible or not” and “whether the information requested by the next service process may be provided or not”.

The “cost” indicates charge and time (time restriction). This service information indicates the charge and the processing time required for the service process. The service process designated can be indicated as “executable with ¥xxxx”, “executable with xx hours”.

The “access right” indicates the condition to permit access to a service or not corresponding to the information of user name and right to access.

The service database 21 stores the service information described above for each of the services. The service information stored in the service database 21 may be one of the previously designated service information and searched service information or may be both of them.

The service registering unit 22 registers the service information transmitted from the service processor to the service database 21. The service registering unit 22 is capable of deleting the service information corresponding to the service processor when the predetermined service processor cannot execute the service due to a fault. The service search unit 23 searches the service (service processor) as the search object on the network 5 and then stores the search result in the service database 21.

The search condition input unit 24 inputs, via the network 5, the search conditions of various service processors. Any search condition may be used as long as it is related to the service information described above. The condition match determining unit 25 collates the search condition inputted to the search condition input unit 25 with the service stored in the service database 21 and searches the service processor matched with the search condition.

The user notifying unit 26 notifies the client terminal 10 of the searched alternative service when it is designated to notify the message to the client terminal 10 as a user. The search result output unit 27 outputs the search result to the service processor which has issued a search request.

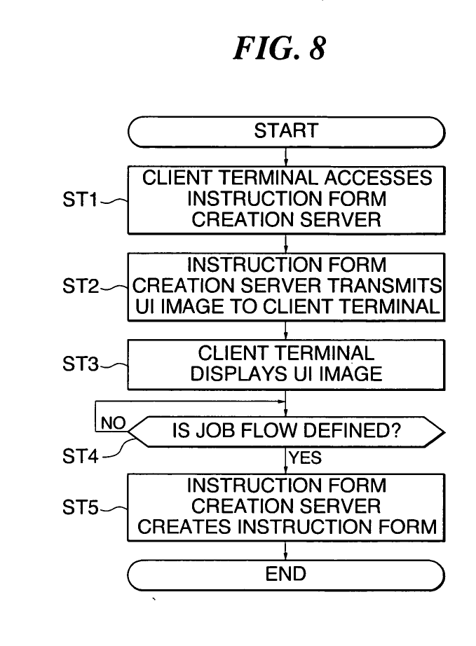

FIG. 8 is a flowchart showing processing procedures of the client terminal 10 and instruction form creation server 30 when the instruction form is created.

The client terminal 10 makes access to the URL of the HTML file created for the user interface image provided with the instruction form creation server 30 through the installed browser in accordance with the user's operations (step ST1).

The instruction form creation server 30 transmits, depending on the read request from the client terminal 10, the HTML file of the user interface image to the client terminal 10 (step ST2).

The client terminal 10 displays a user interface image based on the information forming the image included, for example, in the HTML file transmitted from the instruction form creation server 30 (step ST3). In this timing, a user can define the job flow of the predetermined service cooperation using the user interface image displayed on the client terminal 10.

The client terminal 10 determines whether the job flow has been defined or not via the user interface image and enters the waiting condition until the job flow is defined (step ST4). The client terminal 10 transmits, upon determination that the job flow is created, the job flow information about service cooperation defined with user to the instruction form creation server 30.

The instruction form creation server 30 creates the instruction form which defines the contents of process requested to the service, input parameter, way of cooperation of each service, and information to identify the process object document such as the document name and storing location information or the like, based on the information about job flow of service cooperation transmitted from the client terminal 10 and the I/F information obtained from the service processor (step ST5). Thereafter, the instruction form creation server 30 transmits the instruction form of the XML format to the instruction form management server 40.

The instruction form management server 40 stores the instruction forms created by the instruction form creation server 30. This instruction form management server 40 stores plural instruction forms created by the instruction form creation server 30 and reads the selected instruction form when the client terminal 10 instructs selection of the instruction form.

A user is capable of invoking the cooperated processes by selecting the desired instruction form from plural instruction forms stored in the instruction form management server 40. A specific example is described below.

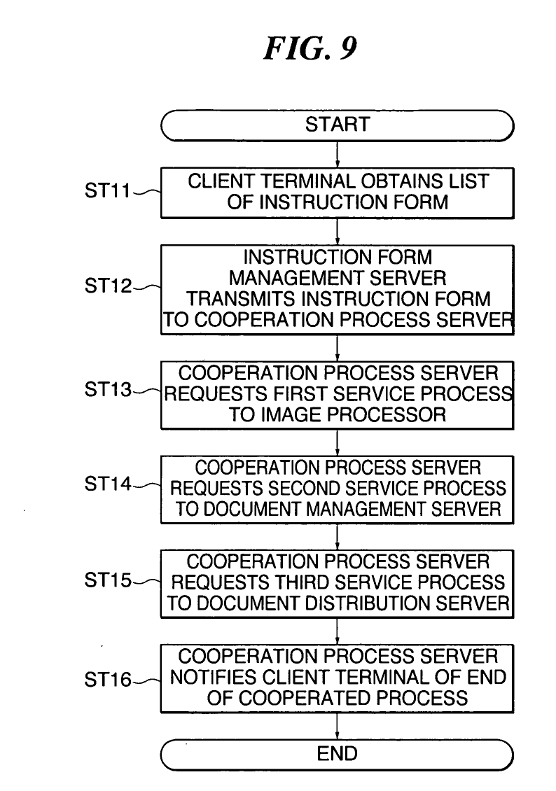

FIG. 9 is a flowchart showing the processes of the client terminal 10, instruction form management server 40 and cooperation process server 50.

The client terminal 10 accesses the instruction form management server 40 to obtain the instruction form list under the management of the instruction form management server 40 (step ST11).

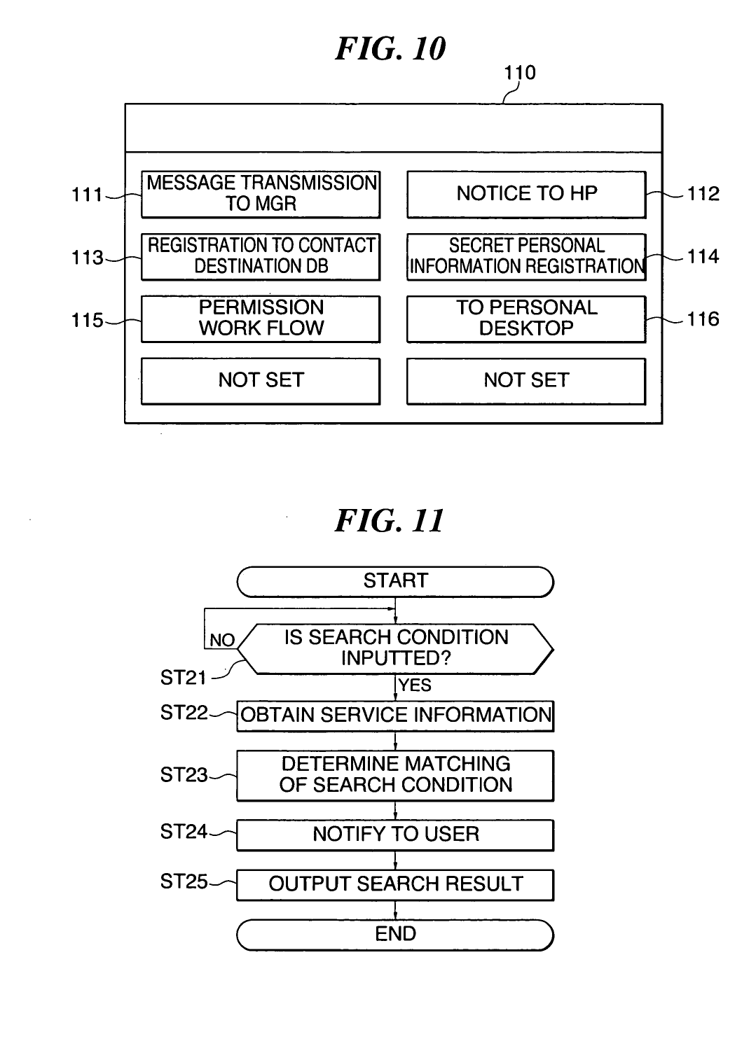

FIG. 10 is a diagram showing an example of the service cooperation process selection image 110 which indicates the instruction form list. The service cooperation process selection image 110 includes the buttons 111 to 116 to select the instruction form for every instruction form. A user is capable of selecting the desired instruction form by clicking the desired button in the service cooperation process selection image 110.

The client terminal 10 selects the instruction form indicating the predetermined service cooperation process from the service cooperation process selection image 110 based on the operation instruction of user and displays, at this time, the parameter input image to user as required and then receives the input of parameter required for execution of job flow. Thereafter, invocation of the selected instruction form is instructed.

The instruction form management server 40 transmits the instruction form instructed by the client terminal 10 to the cooperation process server 50 (step ST12). As a result, the cooperation process server 50 starts execution of the cooperated process.

The cooperation process server 50 interprets the instruction form transmitted from the instruction form management server 40 and sends a request to the image processor 61 requesting the execution of the first service process as the first process described in the instruction form (step ST13). Specifically, the cooperation process server 50 creates, based on the information described in the instruction form, the specific instruction information by extracting a location of the service processor for process request, input parameter and output parameter formats required for a process request, a method name for a process request, an invocation scheme and information to identify the process object document. The cooperation process server 50 transmits the specific instruction information to the image processor 61 as the first process request destination.

The image processor 61 obtains the document by copying the process object document based on the storing destination location information of the process object document described in the instruction form transmitted. The image processor 61 also interprets the service process request contents and executes the image processes such as noise elimination and OCR process to the document image obtained and then executes the binding process with the extracted text document. The image processor 61 stores in the storing source address again the image document obtained through image process and the document to which the text document is bound. The image processor 61 transmits, upon completion of such processes, the process results such as process status information (completion), output parameter and document storing destination information after the process to the cooperation process server 50.

The cooperation process server 50 manages the results of process from the image processor 61 using the log of the first process request result when these results are received. Thereafter, the cooperation process server 50 identifies the second process request destination based on the instruction form and sends a request for execution of the second service process to the document management server 62 (step ST 14). The cooperation process sever 50 transmits, as in the case of the first service process request, the specific instruction information (the information for storing the document as the information about the process request, information of the document storing destination, and information for identifying the process object document) to the document management server 62.

The document management server 62 stores, based on the request contents of cooperation process server 50, the document processed and stored with the preceding process (first service process) based on the storing destination information described in the request contents. The document management server 62 transmits to the cooperation process server 50, upon completion of such processes, the process result such as the status information (completion) of the process, an output parameter and document storing destination information after the process.

The cooperation process server 50 manages the process result from the second service process (document storing process) using the log of the second process request result. The cooperation process server 50 identifies the third process request destination based on the instruction form and sends a request to the document distribution server 63 to execute the third service process (step ST15). The cooperation process server 50 transmits, as in the case of the second service process request, the specific instruction information (the information to store the document which is the information about the process request, the document storing destination information, the information to identify the process object document) to the document distribution server 63.

The document distribution server 63 reads, on the basis of the information to identify the document (storing destination information) the document file which is processed and stored with the preceding process (second service process) based on the request contents of the cooperation process server 50 and then executes the processes described in the request contents. Here, the document distribution server 63 sends mail to the mail address which is designated as the distribution destination of only the text document among the documents where the text document and image document are bound and also sends the facsimile data of only the image document to the designated facsimile address (number). Upon completion of the processes, the document distribution server 63 transmits the process result such as the status information (completion) of the process, an output parameter and document storing destination information after the process or the like to the cooperation process server 50.

In this process, the document distribution server 63 transmits, as the status information, the “mail transmission: completed, facsimile transmission: not yet transmitted” to the cooperation process server 50, for example, when the destination party is busy in the facsimile transmission process and connection cannot be extended to the destination party even after the connection is tried a predetermined number of times.

The cooperation process server 50 receives the process result from the third service process and when it is determined that the next process is not described in the instruction form, notifies the client terminal 10 that all processes are completed in order to complete the cooperated process (step ST16).

(Service Search During Cooperated Process)

The document process system 1 is capable of controlling an alternative service processor to execute the predetermined services when the service processor cannot execute the predetermined services during execution of the cooperated process. In this embodiment, an example that the document distribution server 63 does not accept the process request from the cooperation process server 50 will be described.

When the document distribution server 63 does not accept the service process request, the cooperation process server 50 requests the service search sever 20 to search the service processor which can execute a similar service to that of the document distribution server 63. The cooperation process server 50 analyzes the instruction form when the document distribution server 63 does not accept the service process request, creates the search condition to search the service to replace the document distribution server 63, and transmits this search condition to the service search server 20.

As the search conditions, the service information illustrated in FIG. 7 such as “service function”, “requirement for service”, “provider”, “service location”, “connectivity”, “cost”, and “access right” is preferable.

FIG. 11 is a flowchart showing the processing procedures of the service search server 20 when the service is searched. The service search server 20 executes, upon reception of the search request from the cooperation process server 50, the processes of the step ST21 and the subsequent steps.

The search condition input unit 24 determines whether or not the search condition transmitted by the cooperation process server 50 is inputted and enters the waiting condition until the search condition is inputted (step ST21). When the search condition is inputted, the search condition input unit 24 supplies the search condition to the condition match determining unit 25.

The service search unit 23 searches the service information from the network 5 and registers the searched service information to the service database 21 (step ST22).

The condition match determining unit 25 collates the search condition inputted to the search condition input unit 24 with the service information stored in the service database 21 and determines matching of the search condition to search the service process matched with the search condition (step ST23). For example, the condition match determining unit 25 preferably searches the service matched in the “service function” with the first priority and then searches the service matched in the “cost” when plural items of service information illustrated in FIG. 7 are included in the search condition. The condition match determining unit 25 may search the service matched in the search condition having a higher priority when the service is not perfectly matched with the search condition.

When notification to the client terminal 10 used by a user is designated, the user notifying unit 26 notifies the client terminal 10 of the searched alternative service processor (the other document distribution server) (step ST24). When the plural service processors are searched, the user notifying unit 26 notifies the client terminal 10 of the service list indicating service processors. In this timing, a user is capable of selecting the service actually used from the service list displayed in the client terminal 10.

The search result output unit 27 outputs the search result indicating the alternative service processor to the cooperation process server 50 (step ST25). For example, the search result output unit 27 outputs the <service location information> (URL) of the alternative service processor as the search result. Accordingly, the cooperation process server 50 is capable of making access to the alternative document distribution server in place of the document distribution server 63 to control the server to execute the document distribution process.

As described above, the document processing system 1 of the first embodiment can control the alternative service processor to execute the predetermined service by controlling the service search server 20 to search the alternative service processor when the predetermined service cannot be executed during execution of the cooperated process.

Since the document processing system 1 searches an available alternative service processor during execution of the search in place of the prepared alternative service processor, it can execute the cooperated process even when the structure of network changes dynamically.

The present invention is never restricted to the embodiment described above and can also be adapted to the following embodiment.

A user is capable of designating, as the search condition, a range of search (service location, time or the like). For example, when the search time of 24 hours is given as the search condition, the service search server 20 can search the network 5 for 24 hours until the applicable service appears.

The service search server 20 is also cable of searching the service without acquisition of service information of each service processor. In this case, the service search server 20 can make direct inquiry to each service processor whether the service information corresponds to the predetermined search condition or not.

In addition, the service search server 20 has obtained a part of the service information I/F (partial I/F information) from each service processor, but it can also obtain the entire part of the I/F information.

Next, the second embodiment of the present invention will be described. The elements like those of the first embodiment are designated with the like reference numerals and the detail description will be omitted here.

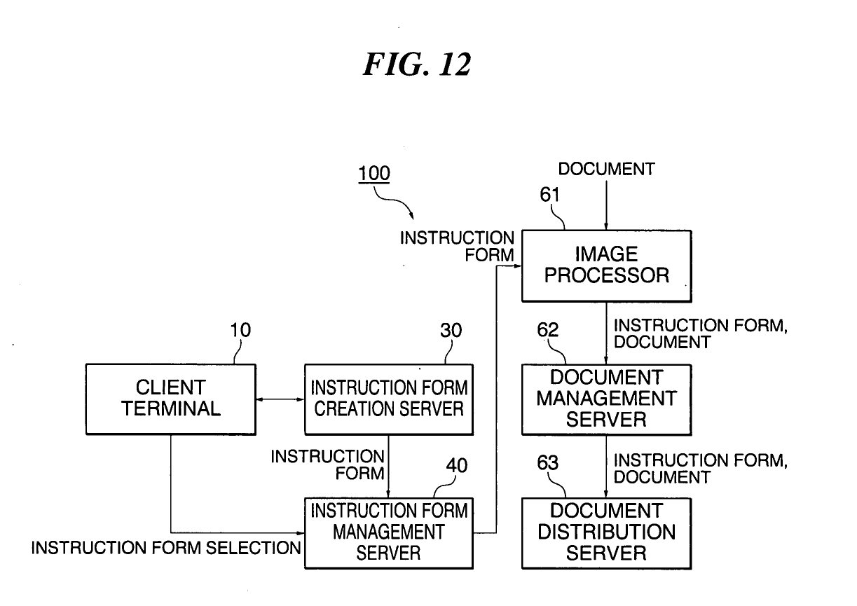

FIG. 12 is a block diagram for describing mutual relationship among service processors forming the document processing system 100 of the second embodiment. The document processing system 100 of the second embodiment can execute the cooperated process of plural services without use of the cooperation process server 50 illustrated in FIG. 1 and FIG. 2.

The document processing system 100 is provided with each service processor (except for the cooperation process server 50) illustrated in FIG. 1 but only the service processor in relation to the cooperated process is illustrated in FIG. 12.

A user is capable of selecting the desirable instruction form from plural instruction forms stored in the instruction form management server 40 and then invoking the cooperated process. The practical processes are as follows.

The client terminal 10 can select the instruction form indicating the desired service cooperation process from the service cooperation process selection image depending on the user's operations and instructs invocation of the instruction form. The instruction form management server 40 transmits the instruction form instructed by the client terminal 10 to the image processor 61.

The image processor 61 obtains the process object document based on the storing destination location information of the process object document described in the instruction form transmitted. In addition, this image processor 61 also interprets the service process request contents and executes noise elimination, image process such as OCR process and binding with the text document extracted to the document image obtained. Moreover, the image processor 61 deletes, after the end of predetermined image process, the service process request described in the instruction form. Thereafter, the image processor 61 transmits the document in which the image document obtained with the image process and the text document are bound and the instruction form including status information (completion) of the process, an output parameter and the process result such as the document storing destination information after the process to the document management server 62 which provides the next service process.

The image processor 61 is also permitted to transmit the service request thereof described in the instruction form through the correction and deletion to the document management server 62 after the end of predetermined image process. The image processor 61 is also capable of transmitting, after the completion of predetermined image process, the instruction form to the next service processor.

The document management server 62 temporarily stores the document transmitted from the image processor 61 in the storing destination described in the instruction form. This document management server 62 also deletes the service process request described in the instruction form and transmits the document and instruction form to the document distribution server 63 which executes the next service.

The document distribution server 63 mails, based on the instruction form, only the text document among the documents in which the text document and image document are bound to the mail address designated as the distribution destination and also transmits only the image document as the facsimile data to the designated facsimile number (address). The document distribution server 63 notifies, upon determination that the next process is not yet described in the instruction form, the client terminal 10 that all processes are completed, and terminates the cooperated process.

The document processing system 100 is capable of making alternative service processors execute the predetermined services when the service processor cannot execute the predetermined service during execution of the cooperated process. In this embodiment, an example where the document distribution server 63 does not accept the process request of the document management server 62 will be described.

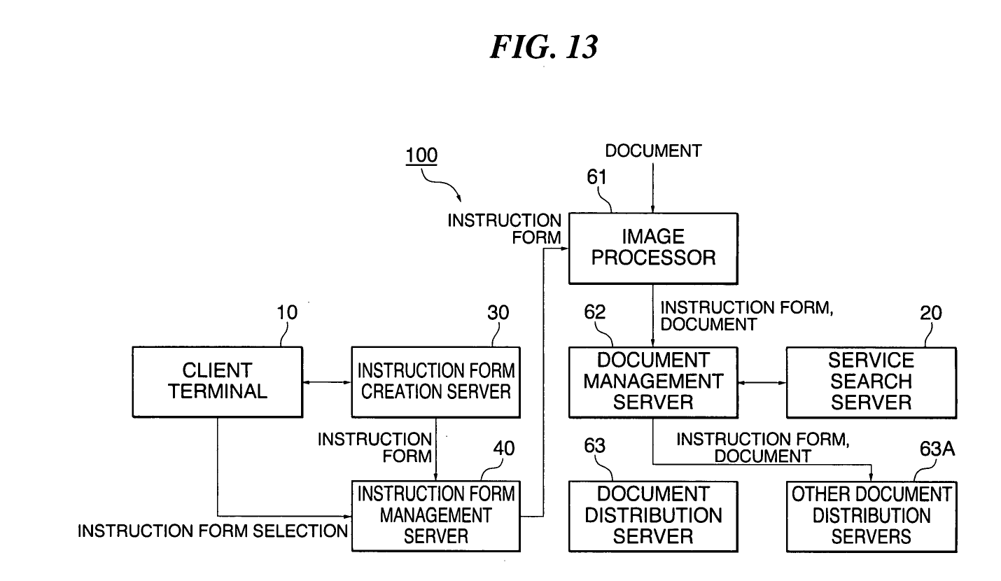

FIG. 13 is a block diagram for describing the mutual relationship during execution of the search of the service processors forming the document processing system 100. The document management server 62 analyzes, when the document distribution server 63 does not accept the service process request, contents of the instruction form and transmits, to the service search server 20, the search condition to search the service similar to that of the document distribution server 63.

The service search server 20 executes, upon reception of the search condition from the document management server 62, the processes, as in the case of the first embodiment, up to the step ST25 from the step ST21 illustrated in FIG. 11. The service search server 20 transmits and receives the search condition and result of search to and from the management process server 62 instead of to and from the cooperation process server 50.

The document management server 62 makes access to the alternative document distribution server 63A in place of the document distribution server 63 and transmits the document and instruction form.

As described above, the document processing system 100 of the second embodiment is capable of making an alternative service processor execute the predetermined service, when it cannot execute the predetermined service during execution of the cooperated process, by instructing the service search server 20 to search the alternative service processor.

In addition, since the document processing system 1 searches, in place of the prepared alternative service processor, an alternative service processor which is available during execution of search, it can execute the cooperated process even when the structure of network changes dynamically.

The present invention is never restricted to this embodiment and allows various changes and modifications within the scope of the claims. For example, the part which may be modified in the first embodiment can also be changed in this embodiment.

The service processor, service search method and program of the present invention can easily search an alternative service processor which may be used at present by searching the service processor which can provide the service corresponding to the search condition from the network in which plural service processors are connected to execute the predetermined processes on the document data and then transmitting the result of search.

The document processing system of the present invention is capable of securely executing the cooperated process by searching an alternative service processor even when it is proved that the predetermined service processor cannot execute the predetermined service during execution of the cooperated process of plural services.

As noted above, the various servers and devices (10, 20, 30, 40, 50 and 61-65) can be individual units or can be combined into one or more than one unit. Each of these servers and devices includes a controller that causes (controls) it to perform the functions described above. Of course if the servers and devices are combined into one or more than one unit, then there would be one or more than one controller to perform the functions described above. Thus, the invention can be implemented by one or more programmed general purpose computers. It will be appreciated by those skilled in the art that the controller can be implemented using a single special purpose integrated circuit (e.g., ASIC) having a main or central processor section for overall, system-level control, and separate sections dedicated to performing various different specific computations, functions and other processes under control of the central processor section. The controller can be a plurality of separate dedicated or programmable integrated or other electronic circuits or devices (e.g., hardwired electronic or logic circuits such as discrete element circuits, or programmable logic devices such as PLDs, PLAs, PALs or the like). The controller(s) can be implemented using a suitably programmed general purpose computer(s), e.g., a microprocessor, microcontroller or other processor device (CPU or MPU), either alone or in conjunction with one or more peripheral (e.g., integrated circuit) data and signal processing devices. In general, any device or assembly of devices on which a finite state machine capable of implementing the procedures described herein can be used as the controller. A distributed processing architecture can be used for maximum data/signal processing capability and speed.

While the invention has been described with reference to preferred exemplary embodiments thereof, it is to be understood that the invention is not limited to the disclosed embodiments or constructions. On the contrary, the invention is intended to cover various modifications and equivalent arrangements. In addition, while the various elements of the disclosed invention are shown in various combinations and configurations, which are exemplary, other combinations and configurations, including more or less or only a single element, are also within the spirit and scope of the invention.

The entire disclosure of Japanese Patent Application No. 2003-081512 filed on Mar. 24, 2003 including specification, claims, drawings and abstract is incorporated herein by reference in its entirety.

What is claimed is:

1. A service search device comprising:
a receiver that receives a search condition for searching a service which executes a process on document data;
a searching controller that searches a service processor for providing the service corresponding to the search condition received by the receiver through a network where a plurality of service processors are connected to execute the process on the document data; and
a transmitter that transmits a search result of the searching controller.

2. The service search device according to claim 1, wherein the searching controller searches a service processor for providing the service corresponding to the search condition by sending an inquiry to each of the plurality of service processors.

3. The service search device according to claim 1, further comprising a service information memory that stores service information indicating the service provided by each of the plurality of service processors, wherein the searching controller searches the service processor for providing the service corresponding to the search condition from the service information stored in the service information memory.

4. The service search device according to claim 1, wherein the transmitter transmits a list of one or more service processors searched by the searching controller.

5. The service search device according to claim 1, wherein the receiver receives, as the search condition, at least one of a service function, a provider to provide the service, a requirement to execute the service, a charge of the service, time of the service and an access right to the service.

6. A service search device comprising:
receiving means for receiving a search condition for searching a service which executes a process on document data;
searching means for searching a service processor for providing the service corresponding to the search condition received by the receiving means through a network where a plurality of service processors are connected to execute the process on the document data; and
transmitting means for transmitting a search result of the searching means.

7. The service search device according to claim 6, wherein the searching means searches a service processor for providing the service corresponding to the search condition by sending an inquiry to each of the plurality of service processors.

8. The service search device according to claim 6, further comprising a service information storing means for storing service information indicating the service provided by each of the plurality of service processors, wherein the searching means searches the service processor for providing the service corresponding to the search condition from the service information stored in the service information storing means.

9. The service search device according to claim 6, wherein the transmitting means transmits a list of one or more service processors searched by the searching means.

10. The service search device according to claim 6, wherein the receiving means receives, as the search condition, at least one of a service function, a provider to provide the service, a requirement to execute the service, a charge of the service, time of the service and an access right to the service.

11. A service search method comprising the steps of:
receiving a search condition for searching a service which executes a process on document data;
searching a service processor for providing the service corresponding to the search condition received by the receiving step through a network where a plurality of service processors are connected to execute the process on the document data; and
transmitting a search result of the searching step.

12. The service search method according to claim 11, wherein the service processor for providing the service corresponding to the search condition is searched by sending an inquiry to each of the plurality of service processors in the searching step.

13. The service search method according to claim 11, further comprising the step of:
storing service information indicating the service provided by each of the plurality of service processors.

14. The service search method according to claim 11, wherein a list of one or more service processors searched in the searching step is transmitted in the transmitting step.

15. The service search method according to claim 11, wherein at least one of a service function, a provider to provide the service, a requirement for execution of the service, a charge of the service, time of the service and an access right to the service is received as the search condition at the receiving step.

16. The service search method according to claim 13, wherein the service processor for providing the service corresponding to the search condition is searched in the searching step by referring to service information indicating the service provided by each of the plurality of service processors.

17. A document processing system comprising:
a service search device which comprises a receiver that receives a search condition for searching a service which executes a process on document data, a searching controller that searches a service processor for providing the service corresponding to the search condition received by the receiver through a network where a plurality of service processors are connected to execute the process on the document data, and a transmitter that transmits a search result of the searching controller; and
a cooperation process device to execute the cooperated process of plural services based on cooperation instruction information indicating the cooperated process of plural services on a network,
wherein the cooperation process device transmits, when a service processor indicated by the cooperation instruction information cannot be used for execution, a search condition to search another service processor corresponding to the predetermined service processor from the network to the service search device, receives a search result from the service search device, and makes the other service processor indicated by the received search result execute the process in place of the predetermined service processor.
